(19) United States
(12) Patent Application Publication
(10) Pub. No.: US 2024/0245251 A1
(43) Pub. Date: Jul. 25, 2024

(54) GASEOUS STATE HEAT TRANSFERENCE FOOD COOKING

(71) Applicant: HIGH ENERGY ENGINEERING LLC, MUNCIE, IN (US)

(72) Inventor: Alex Spencer CREVISTON, Munice, IN (US)

(21) Appl. No.: 18/420,176

(22) Filed: Jan. 23, 2024

Related U.S. Application Data
(60) Provisional application No. 63/481,476, filed on Jan. 25, 2023.

(51) Int. Cl. A47J 27/00

(52) U.S. Cl. CPC A47J 27/004

(57) ABSTRACT

Devices, systems, and methods for food cooking thermal transfer can utilizes a pump driven gaseous state flow coupled with an electrically powered heating device. The arrangement can include a control system with sensors to measure gas temperature and/or velocity to optimize the gas state parameters for heat transfer or temperature maintenance.

### CROSS-REFERENCE

This US utility patent application claims the benefit of priority of provisional patent application No. 63/481,476, filed on Jan. 25, 2023, and titled NOVEL GASEOUS STATE HEAT TRANSFERENCE DEVICE, the contents of which are incorporated by reference herein in their entirety.

### FIELD

The disclosure is related to the field of heat exchange, more specifically, cooking and heat exchange, imparting temperature changes into a cooking or holding vessel by means of a fluid medium.

### BACKGROUND

Natural gas combustion ranges are noted for superior heating and cooking capability over typical electric ranges due to faster heating and more precise temperature control. Slow response and long warm up times with electric ranges are caused by the large thermal inertia of the heating elements and surfaces as well as low heat transfer rates with an all-conductive system. Natural gas combustion heat transfer can be better and/or faster due to immediate heat production at flame ignition and/or enhanced heat transfer due to flame impaction and/or velocity of heated gas flowing around the cooking surfaces. The gaseous flow around a containment vessel can increase both the thermal transfer rates and the effective engaged surface area of the heat transfer.

### SUMMARY

In an exemplary embodiment, combination of an electrically generated heat source with a forced gas stream can yield close to instant heat availability with a high degree of temperature control and enhanced thermal transfer characteristics. Gaseous flow with electrically powered heating allows for variations in nozzle design, gas flow volume and velocity with multiple options for temperature control including changes in gas volume or velocity or changes in thermal energy input.

In one embodiment, a thermal transfer device combines forced moving gas with an electrically energized heating source, combining the ease and simplicity of electric connections and the heating power and control of gas combustion while eliminating the byproducts of burning natural gas or propane.

The system consists of a gas pump, an electrically powered heat source, a definitive gas flow path, a region where the flowing gas accepts thermal energy from the electrical source and a gas flow outlet. Temperature control is achieved by varying the electrical power input or changing the air flow around the elements or some combination thereof. Power control is achieved by the reduction of electrical energy supplied to the heat generation device; thus, power and temperature control are at least partially independent from one another.

Heat transfer by flame impingement from burning gas has limited options for improving heat transfer, but shaped, directed air streams and or jets can be utilized and engineered to enhance heat transfer. In addition, the directed air streams may be used to remove heat for cooling of cooking surfaces. Variable, engineered geometries influencing the thru, or outgoing air flow could be employed to vary the air stream temperature, pressure and velocity. A sub ambient producing vortex tube could allow for air cooling prior to interaction with the heating element stage allowing for greater heat transfer and a higher potential outlet temperature. Internal vortex cooling systems could also be used to introduce sub ambient temperature air to the cooking vessel for rapid cooling. Variable nozzle geometries may be used to increase the air velocity thus reducing the boundary layer thickness at the vessel surface, increasing the thermal transfer. In some embodiments, the air flow and velocity for various vessel materials such as glass, ceramic, aluminum, cast iron and stainless steel is tailored to respond differently to various air flow characteristics.

One embodiment incorporates individual tubes as the distinct flow path. The utilization of individual tubes allows for a singular heat generation element that can be replicated as much as desired to achieve the desired power per cooking station. With individual elements the size and shape of cooking stations are at least partially decoupled from the heating element allowing for a wide range of sizes, shapes and power levels without redesign of the actual heat generating device.

Each individual heating element may be controlled with a relay or PWM control system thus eliminating the need for large electrical currents to supply a singular heating element. A PCB connection system could be employed to connect all elements for ease and flexibility. The directed air system may also greatly reduce the heating present in the control area of the cooking platform reducing the temperature related stress on components.

Another embodiment utilizes a manifold arraignment to distribute the moving gas. The manifold may incorporate a singular heating element or multiple heating elements with multiple gas flow tubes.

### BRIEF DESCRIPTION OF THE DRAWINGS

A more comprehensive understanding of the disclosed embodiments and the benefit thereof may be obtained by referring to the following descriptions in contemplation of the attendant drawings, in which like reference numbers indicate like features, and wherein:

FIG. 1 shows the basic arraignment of the device in accordance with an embodiment including a pump, flow path, electric heat element, heat transfer zone and gas exit area.

FIG. 2 shows the device with the addition of a control unit that monitors the exit gas temperature and velocity and controls the gas pump.

FIG. 3 shows the device with a heating element comprised of an electrical resistance interior to the flow path.

FIG. 4 shows the device with a heating element comprised of an inductively excited element interior to the flow path.

FIG. 5 shows the device with a heating element comprised of the flow path being an inductively excited element.

FIG. 6 shows the device gas exit flow interacting with a cooking vessel.

FIG. 7 shows a utilization of a vortex tube with above and below ambient outlets.

FIG. 8 shows the incorporation of a venturi in a flow path to change the velocity pressure and temperature of the flowing gas.

FIG. 9 shows the use of a nozzle to increase the velocity of the exit gas.

FIG. 10 shows a variable nozzle to allow changes to the outgoing velocity of the exit gas to vary the impingement of the gas on a cooking or other vessel.

FIGS. 11 and 12 are manifold arraignments with single or multiple gas heating devices.

FIGS. 13, 14 and 15 show a plurality of flow devices in various arrangements and geometries for power enhancement or area coverage.

In order to promote an understanding of the keys of the disclosure, reference will be made to the embodiments illustrated in the drawings detailed below. The embodiments detailed below are not meant to be comprehensive or limit the disclosure to the precise form disclosed in the following description. Rather, the embodiments are selected and described so that others skilled in the art may utilize their teachings. It will be understood that no limitation of the scope of the disclosure is thereby intended. The disclosure includes any modifications and or further adaptations in the illustrative contrivances and further applications of the principles of the disclosure which would normally occur to one skilled in the art to which the disclosure relates. Unless otherwise indicated, the components in the drawings are shown comparatively sized to one another.

### DETAILED DESCRIPTION OF THE DRAWINGS

Using an electrical apparatus as a heat transference device for food preparation or other activities has advantages of easy connections and zero emissions. Enhancing the ability of electrically powered cooking is desirable to increase the utilization and acceptance of said devices. Enhancing the thermal transfer performance and temperature control is key to improving the overall device operation. To accomplish this, a thermal transference device 100 described below consists of a gaseous state pump, a definite flow path, an electrically powered heating generation device, a heat exchange zone and a gas outlet.

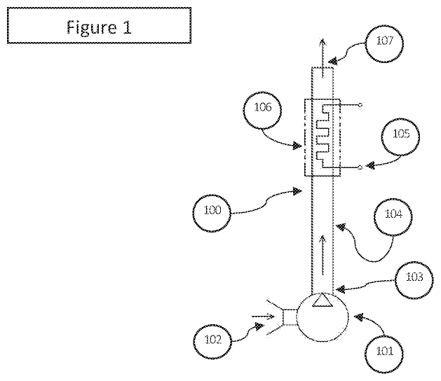

FIG. 1 shows gaseous heat transference device 100 including pump 101, pump intake 102, pump outlet 103, gas flow path 104, heat generation element 105, heat transfer zone 106 and gas flow exit area 107. The pump 101 generates a flow from the intake 102 to the outlet 103 and into the path at 104. The flowing gas passes through the area demarked as 106 to interact with the heat generation element 105. If element 105 is at a temperature greater than the flowing gas, then the gas will exit at 107 with a higher temperature then it entered the pump 101.

FIG. 2 shows gaseous heat transference device 200 including pump 201, heat generation element 205, the system monitoring and control system 208, the pump control link 209, heating element control line 210, gas velocity sensing 211 and temperature sensing 212. The monitoring and control system 208 is used to change the power imparted into heating element 205 thru the control line 210 or change the pressure and or flow of the gas by changing the operational parameters of the pump 201, in some embodiments.

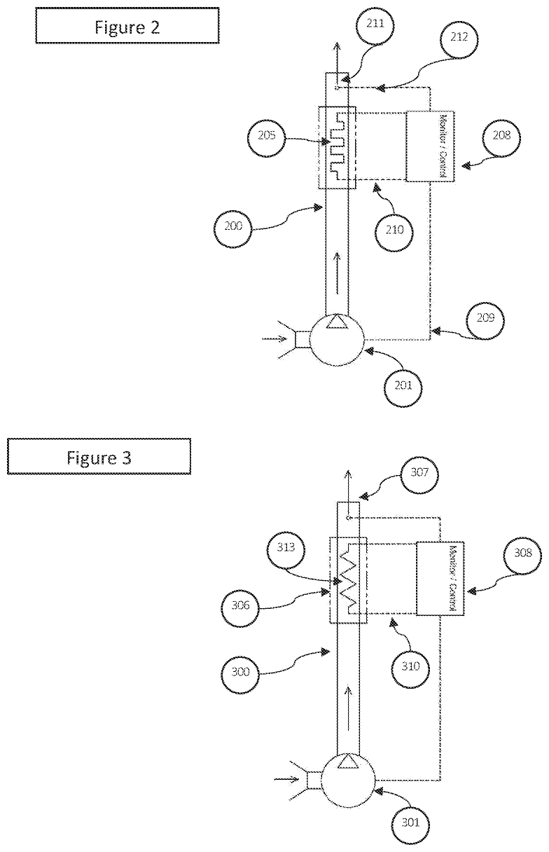

FIG. 3 illustrates gaseous heat transference device 300 including pump 301, heat transfer zone 306, gas flow exit area 307, control system 308, heat element control line 310, resistive heating element internal to the flow path 313.

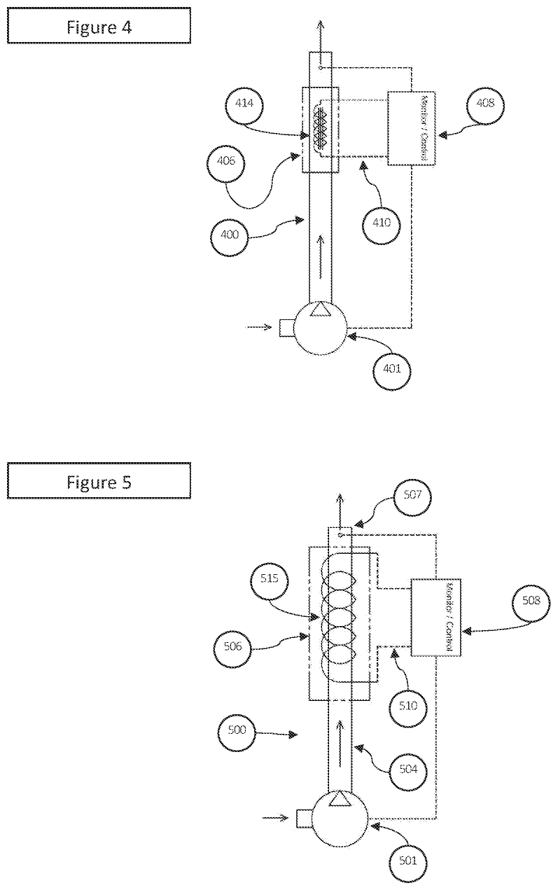

FIG. 4 illustrates gaseous heat transference device 400 including pump 401, heat transfer zone 406, control system 408, heat element control line 410, inductively excited heating element internal to the flow path 414.

FIG. 5 illustrates gaseous heat transference device 500 including pump 501, heat transfer zone 506, control system 508, heat element control line 510, device 515, to inductively excite the flow path, 504, so the flow path is used as the heating element, in some embodiments. If the temperature of the zone at 506 is greater than the flowing gas in 504, then the gas will exit at 507 with a higher temperature then it entered the pump 501.

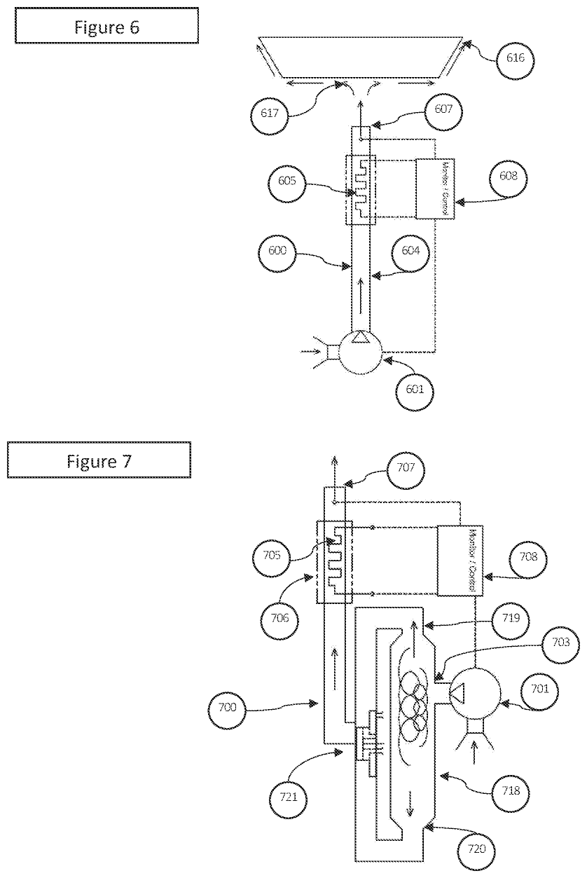

FIG. 6 shows gaseous heat transference device 600 including pump 601, gas flow path 604, heat generation element 605, gas flow exit area 607, control system 608, cooking vessel 616, and gas impingement area 617, from gas exit area 607, to cooking vessel 616. The gas impingement at 617 and the subsequent boundary including the gas and cooking vessel 616 encompasses the major thermal transfer between the gas and cooking or other vessel.

FIG. 7 illustrates gaseous heat transference device 700 including pump 701, pump outlet 703, heat generation element 705, heat transfer zone 706, gas exit area 707, control system 708, Ranque-Hilsch vortex tube 718, vortex tube 718 below ambient side outlet 719, vortex tube 718 above ambient side outlet 720, vortex tube 718 outlet flow path selector device 721. The flowing gas enters the vortex tube 718 at pump outlet 703, the vortex tube produces a higher than ambient temperature flow at 720 and a lower than ambient temperature flow at 719. The selection device 721 allows the control system 708 to select either a sub ambient or above ambient gas flow to be introduced to the heat transfer zone 706. Utilization of the sub ambient flow allows for a greater temperature delta between the gas flow and the heat generation element 705 to enhance thermal transfer. The above ambient flow stream is used for temperature control without the additional use of the heat generation element, in some embodiments. Alternatively, the sub ambient flow is used for rapid cooling of a cooking or other vessel, not shown, if so desired, in some embodiments.

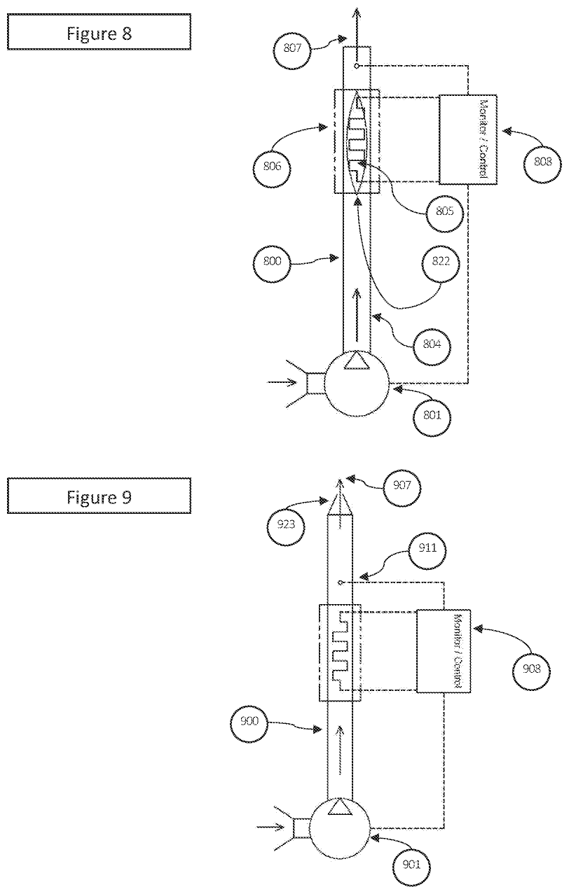

FIG. 8 shows gaseous heat transference device 800 including pump 801, gas flow path 804, heat generation element 805, heat transfer zone 806, gas exit area 807, control system 808, venturi device 822. The flowing gas exits the pump 801 and enters the flow path 804. As the gas flow interacts with the venturi device 822 the thermodynamic properties of the gas are changed to enhance the interaction with the heat generation element 805 throughout the transfer area 806.

FIG. 9 shows the gaseous heat transference device 900 including pump 901, gas exit area 907, control system 908, gas velocity sensor 911 and gas exit nozzle 923. As the gas exits the device the nozzle increases the velocity of the gas to ultimately increase the heat transfer upon impingement with a cooking or other vessel due to a decreased boundary layer at the impingement site and increased turbulence over the balance of area of the vessel.

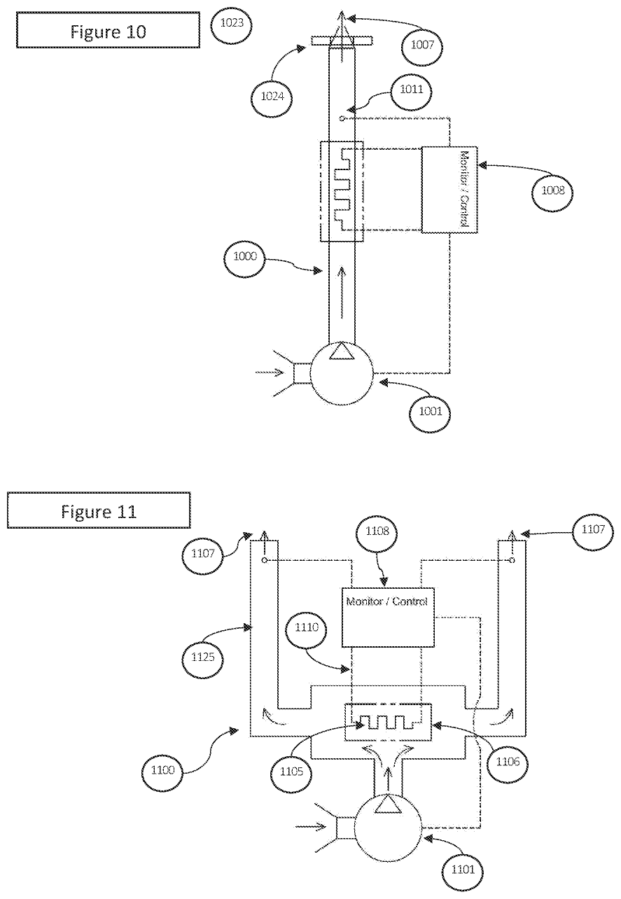

FIG. 10 shows the gaseous heat transference device 1000 including pump 1001, gas exit area 1007, control system 1008, gas velocity sensor 1011, gas exit nozzle 1023 and nozzle control device 1024. As the gas exits the device the nozzle increases the velocity of the gas to ultimately increase the potential heat transfer upon impingement with a cooking or other vessel due to a decreased boundary layer at the impingement site and increased turbulence over the balance of area of the vessel. The control system 1008 utilizes the gas velocity sensor 1011 and if necessary, adjusts the control device 1024 to change the exit velocity. The control device changes the parameters of the pump 1001 in addition to the nozzle control device 1024 to optimize the output gas properties, in some embodiments. Variable velocity rates are important to enhance the heat rate of change for various vessel materials, in some embodiments. For example, the ideal rate for glass may be different than the ideal rate for aluminum or stainless steel.

FIG. 11 shows the gaseous heat transference device 1100 including pump 1101, heat generation element 1105, heat transfer zone 1106, gas exit area 1107, control system 1108, heating element control line 1110, flow manifold 1125. The system is shown with a singular heating element and pump but multiple outlet flow paths. The manifold is used to decrease complexity, cost or volume while providing multiple gas stream outlets, in some embodiments.

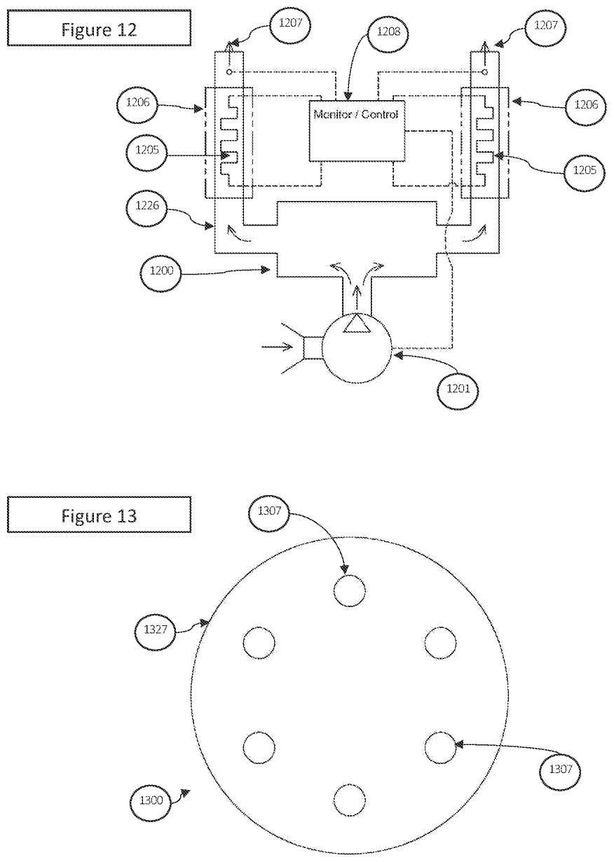

FIG. 12 shows the gaseous heat transference device 1200 including pump 1201, heat generation element 1205, heat transfer zone 1206, gas exit area 1207, control system 1208, flow manifold 1226. The system is shown with a single pump but multiple heating elements, one for each of the multiple outlet flow paths. The manifold is used to decrease complexity, cost or volume while providing multiple gas stream outlets, in some embodiments. Multiple heating elements are used to increase the power density of the overall system, in some embodiments. Enhanced control is also possible with multiple elements as the thermal power imparted into each flow path is controlled independently, in some embodiments.

FIG. 13 illustrates a potential arrangement 1327 of the gaseous transference device 1300 gas flow exit areas 1307. The exit areas may be associated with individual tubes or with a manifold system.

FIG. 14 illustrates an embodiment of an arrangement 1428 of the gaseous transference device 1400 gas flow exit areas 1407. The exit areas may be associated with individual tubes or with a manifold system. The number of exit areas associated with a particular geometric plan is changed, in some embodiments, to enhance the power capacity of the system, the overall flow potential or the coverage area.

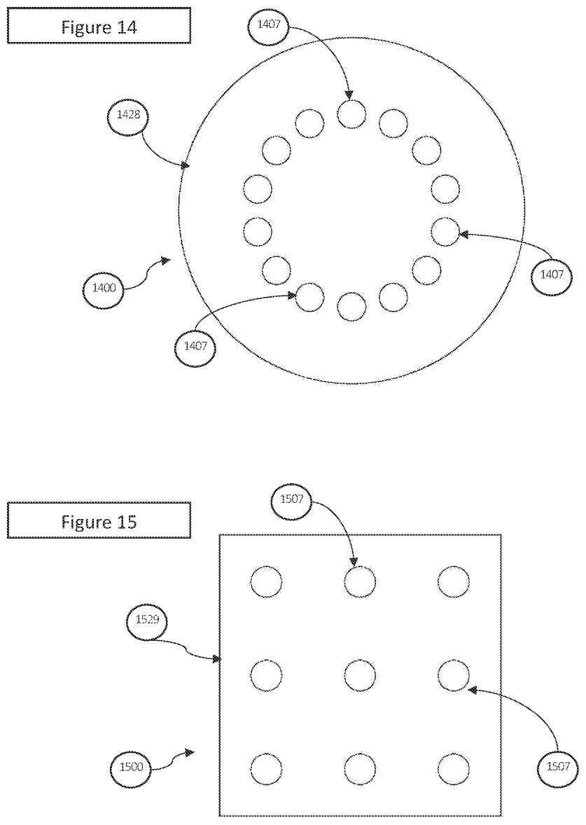

FIG. 15 illustrates an embodiment of an arrangement 1529 of the gaseous transference device 1500 gas flow exit areas 1507. The exit areas may be associated with individual tubes or with a manifold system. The shape of potential groupings of the various exit areas is flexible and adaptable to fit a multitude of potential layouts.

In an aspect of the embodiments described herein, a heat transfer system is provided to impart thermal energy to a vessel. The system includes a flow path for conducting a gaseous state fluid. A pump directs the gaseous state fluid through the flow path. An electrically powered heat producing element is provided. A transfer zone is provided in the flow path to impart thermal energy onto the gaseous state fluid from the heat producing element. An outlet discharges the gaseous state fluid from the flow path.

In some embodiments, a control system is provided to (at least one of) monitor the exit temperature of the gaseous state fluid, vary an exit temperature of the gaseous state fluid by varying an electrical power supplied to the heat producing element, and vary the exit temperature of the gaseous state fluid by varying a flow of the gaseous state fluid through the flow path.

In some embodiments, the heat producing element is at least one of a resistive electric heating element, an inductively excited heating element, a carbon arc, an electrically generated plasma, an infrared light source, an ultrasonic exciter, a LASER, a radio frequency exciter, and externally heated steam.

In some embodiments, the flow path is a single tube flow path. In some embodiments, the heat producing element is interior to the single tube.

In some embodiments, the flow path is a manifold tube system. In some embodiments, the system includes, a single heat producing element. In some embodiments, the system includes multiple heat producing elements.

In some embodiments, the flow path includes at least one of a vortex tube that discharges sub ambient air into the thermal transfer zone and a vortex tube that discharges above ambient air into the thermal transfer zone.

In some embodiments, a variable nozzle geometry fluctuates an exit velocity of the gaseous state fluid.

In some embodiments, a flow of the gaseous state fluid from the thermal transfer system is used to cool the vessel.

In some embodiments, a flow of the gaseous state fluid from the thermal transfer system is maintained at a constant temperature.

In some embodiments, the pump is at least one of a scroll pump, a diaphragm pump, and a piston pump.

What is claimed is:

1. A food cooking system to impart thermal energy to a food vessel, the food cooking system comprising:
a flow path for conducting a gaseous state fluid,
a pump to direct the gaseous state fluid through the flow path,
an electrically powered heat producing element,
a transfer zone in the flow path to impart thermal energy onto the gaseous state fluid from the heat producing element for heating the food vessel, and
an outlet to discharge the gaseous state fluid from the flow path.

2. The thermal transfer system of claim 1, including a control system that at least one of monitors the exit temperature of the gaseous state fluid, varies an exit temperature of the gaseous state fluid by varying an electrical power supplied to the heat producing element, and varies the exit temperature of the gaseous state fluid by varying a flow of the gaseous state fluid through the flow path.

3. The thermal transfer system of claim 1, wherein the heat producing element is at least one of a resistive electric heating element, an inductively excited heating element, a carbon arc, an electrically generated plasma, an infrared light source, an ultrasonic exciter, a LASER, a radio frequency exciter, and externally heated steam.

4. The thermal transfer system of claim 1, the flow path is a single tube flow path.

5. The thermal transfer system of claim 1, wherein the heat producing element is interior to the single tube.

6. The thermal transfer system of claim 1, wherein the flow path is a manifold tube system.

7. The thermal transfer system of claim 6, comprising a single heat producing element.

8. The thermal transfer system of claim 6, comprising multiple heat producing elements.

9. The thermal transfer system of claim 1, wherein the flow path includes at least one of a vortex tube that discharges sub ambient air into the thermal transfer zone and a vortex tube that discharges above ambient air into the thermal transfer zone.

10. The thermal transfer system of claim 1, further comprising a variable nozzle geometry to fluctuated an exit velocity of the gaseous state fluid.

11. The thermal transfer system of claim 1, wherein a flow of the gaseous state fluid from the thermal transfer system is used to cool the food vessel.

12. The thermal transfer system of claim 1, wherein a flow of the gaseous state fluid from the thermal transfer system is maintained at a constant temperature.

13. The thermal transfer system of claim 1, wherein the pump is at least one of a scroll pump, a diaphragm pump, and a piston pump.
